(19) United States
(12) Patent Application Publication
(10) Pub. No.: US 2008/0231593 A1
(43) Pub. Date: Sep. 25, 2008

(54) Electrophoretic Display Device

(75) Inventors: Mark Thomas Johnson, Eindhoven (NL); Guofu Zhou, Eindhoven (NL); Neculai Ailenei, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,068

(22) PCT Filed: Feb. 17, 2005
(86) PCT No.: PCT/IB2005/050592

§ 371 Date: Aug. 17, 2006

(30) Foreign Application Priority Data
Feb. 24, 2004 (EP) 04100718.8

(51) Int. Cl. G09G 3/34

(52) U.S. Cl. 345/107

(57) ABSTRACT

The electrophoretic display panel has an electrophoretic medium having charged particles, a plurality of picture elements, electrodes associated with each picture element for receiving a potential difference, and drive means. The drive means are arranged for controlling the potential difference of each of the plurality of picture elements to be a potential difference for enabling the particles to occupy the position corresponding to image information. For the display panel to be able to provide a smoother change-over from one image to another, the drive means are arranged for providing, during a portion of the image transition period, different starting times for application of the potential differences within the duration of the portion of the transition period for potential differences having a duration less than the maximum duration of the portion of the image transition period.

The invention relates to an electrophoretic display panel, comprising:

an electrophoretic medium comprising charged particles;

a plurality of picture elements;

electrodes associated with each picture element for receiving a potential difference

the charged particles being able to occupy extreme positions near the electrodes and intermediate positions in between the electrodes; the extreme positions being associated with extreme optical states; and

drive means,

the drive means being arranged for providing, within an image transition period, the image transition period comprising one or more portions, to each of the plurality of picture elements

a grey scale potential difference, during a grey-scale driving portion of the image transition time period, for causing the particles to occupy the position corresponding to image information.

The invention also relates to a method for driving an electrophoretic display device in which method potential differences are applied to an array of picture elements of the display device within a transition (or update) period, the image transition period comprising one or more portions, for providing a change of image on the display device, wherein within an image transition period, the image transition period comprising one or more portions, to each of the plurality of picture elements a grey scale potential difference is provided during a grey-scale driving portion of the image transition time period, for causing the particles to occupy the position corresponding to image information.

An embodiment of the electrophoretic display panel of the type mentioned in the opening paragraph is described in International Patent Application WO 03/079323.

In the described electrophoretic display panel, each picture element has, during the display of the picture, an appearance determined by the position of the particles. During an image transition period a change of image is effected. The drive means provide potential differences to the picture elements. These potential differences have an effect on the charged particles. The image transition period comprises one or more portions in which a certain effect is produced. During a grey scale driving portion of the image transition period grey scale potential differences are provided to the picture elements for causing the charged particles to substantially occupy the position according to image information. In principle, the position of the charged particles then corresponds to the image information. The position of the particles depends, however, not only on the momentary potential differences applied during the grey scale driving portion but also on the history of the potential differences. In the prior art a reset potential difference is applied during a reset portion of the image transition period, which reset portion precedes the grey scale driving portion within the image transition period. As a result of the application of the reset potential differences the dependency of the appearance of the picture element on the history is reduced, because it is made sure that charged particles substantially occupy one of the extreme positions before a grey scale potential difference is applied. Thus the picture elements are each time reset to one of the extreme optical states. Grey scales can be created in the display device by controlling the amount of particles that move to counter electrode at the top of the microcapsules by application of grey scale potential difference to the reset elements. For example, the energy of the positive or negative electric field, defines as the product of field strength and time of application, controls the amount of particles moving to the top of the microcapsules. “Grey scale” is to be understood, within the concept of the present invention, to mean any intermediate state between the extreme optical states. When the display is a black and white display, “grey scale” indeed relates to a shade of grey, when other types of colored elements are used ‘grey scale’ is to be understood to encompass any intermediate state in between extreme states. When the image information is changed the picture elements are reset.

The inventors have realized that during the image transition period, e.g. during application of the reset voltages and/or grey scale potential differences, i.e. during the reset portion and/or grey scale driving portion of the image transition period, the image on the display may show erratic changes in the image which are unappealing to a viewer. In particular the change-over from one image to another may be quite unappealing and erratic.

It is an object of the invention to provide a display panel and method of any of the kinds mentioned in the opening paragraphs which is able to provide a smoother change-over from one image to another.

The device in accordance with the invention is characterized in that the drive means are arranged for providing, during said one or more portions of the image transition period, different starting times for the application of the potential differences within said one or more portions of the transition period for potential differences having a duration less than a maximum duration for said portion of the image transition period.

Portions of the image transition period (or image update period) can, within the concept of the invention, comprise a reset portion, an over-reset portion or a grey scale driving portion of the image transition period.

During a reset portion of the image transition period reset potential differences are applied to bring the picture element from a starting optical state into an extreme optical state. An over-reset portion is equivalent to a reset portion, with the only difference that the time during which the reset potential differences are applied is deliberately chosen to be too long for a nominal effect. Over-resetting is thus a kind of resetting in which reset potentials are applied for a duration which is considerably longer than nominally needed to bring a picture element to an extreme optical state.

Within a portion of the image transition period, be it a reset, an overreset or a grey scale driving portion, potential differences, e.g. reset, overreset or grey scale potential differences, are applied to the picture elements to produce a certain effect for or within the picture element. The duration of the application of the relevant potential difference will show a variation. For some picture elements the relevant potential difference will be applied for a short period of time, for other for a longer time, and for yet others for the longest time period.

The length or maximum duration of a particular portion of the image transition period is given by the maximum duration of application of the potential difference associated with said portion, which is the duration to bring about the largest possible change in the position of the charged particles within said portion. In a display device in accordance with the invention the starting times of the application of the potential difference is different for different length of application, while yet all applications fall within the maximum duration. This leads to a distribution of the applications over and within the maximum duration of the particular portion of the image transition period which leads to a smoothening of the change in the image during the relevant portion. Preferably the drive means are arranged such that the starting times for the application of the potential differences of substantially equal, less than maximum, duration.

The same duration of application of a potential difference may occur even though the optical state before and after the application differ. In the preferred embodiment the driving means are arranged such that in operation the starting times differ for those transitions having a substantially equal length for the duration of the application of a potential difference within the said portion. Prima facie it would seem logical to treat all pulses (i.e. application of a potential difference) having the same duration equal, i.e. have them start and thus also end at the same instant in time. However, by providing one or more differences in starting time between pulses with equal length a better distribution of changes in the image over the relevant portion and thus a more smooth image transition is provided.

The invention in its basic or in preferred embodiments can be embodied in various embodiments.

The device in accordance with a first preferred embodiment of the invention is characterized in that the drive means are arranged for providing different starting times for application of the grey scale potential difference within the grey scale driving portion of the transition period for grey scale potential differences having an application duration less than the maximum duration for the grey scale driving portion.

Preferably the starting times for transitions having a substantially equal duration for the grey scale potential difference differ.

When changing the image directly from one grey scale to another without using a reset, the length of the drive period is determined by the longest grey scale potential difference, from one state to another. However, not all transitions require the same application duration of grey scale potential difference. For instance when there are two extreme optical states the longest enduring grey scale potential difference is applied because the picture element is going from one extreme optical states (black or white) to the other (white or black); starting from an intermediate “grey” state a shorter grey scale potential difference may be applied. There are several such “shorter” grey scale potential differences possible, depending on the starting optical state and the to be reached optical state. Several transitions will have the substantially same length, for instance going from dark grey to black will have a substantially as long a length as going from light grey to white. The concept of the invention is that, if one considers transitions, i.e. transitions from an initial state to a final optical state (grey scale potential difference or driving pulse) and one compares transitions having a less than maximal length, these grey scale potential differences start (and thus also end) at different points within the longest driving period. The “less than maximal driving time” driving pulses are distributed within the longest driving period. Preferably they all end within said longest driving period.

In prior art driving schemes the control means are arranged such that the driving pulse(s), i.e. the potential differences determining the grey scale are initiated at substantially the same time. For example all driving waveforms start to be implemented as soon as an image update signal is issued by the display controller. Although this is a convenient method for driving the display, the inventors have realized that this is a cause for the effect that new images appear in a somewhat irregular manner. The user perceives a new image which appears in an irregular manner across the display, which results in a rather “bitty” image update which is not preferred by the viewer. The different driving waveforms have different durations and for this reason, whilst the image update of all pixels is initiated at substantially the same point in time, i.e. all at the start of the grey scale driving period, the time at which the new image appears varies from element to element dependent of the details of the previous image and the new image, leading to the “bitty” appearance of a new image. Due to the distribution of application grey scale potential differences within the maximum grey scale driving time this effect is reduced in the invention.

In a device in accordance with a further preferred embodiment of the invention, the drive means are arranged for providing, within a reset portion of the image transition period, said reset portion preceding the grey scale driving portion, to each of the plurality of picture elements

a reset potential difference for causing the particles to substantially occupy an extreme position before application of the grey scale potential difference,

wherein the drive means are arranged for providing different starting times for application of the reset potential difference within the reset portion of the image transition period for transitions in which the duration of the application of the reset potential difference is less than the maximum duration of the reset portion.

The maximum length of the reset portion of the image transition period is determined by the longest reset potential difference, i.e. the time required to bring a picture element from one extreme state to another. This defines the maximum duration of the reset portion of the transition time However, not all reset transitions require the same length of application of reset potential difference. For instance when there are two extreme optical states the longest reset potential difference during resetting is applied when the picture element is going from one extreme optical states (black or white) to the other (white or black); starting from an initial intermediate “grey” state a shorter reset potential difference may be applied. There are several such “shorter” reset potential differences possible, depending on the starting optical state and the to be reached extreme optical state. Several transitions from a starting optical state to an extreme optical state will have substantially the same duration. For instance, resetting from dark grey to black will take substantially as long as resetting from light grey to white. The concept of the invention is that, if one considers transitions, i.e. transitions from an initial state via an extreme optical state (reset) to a final optical state (grey scale potential difference or driving pulse) and one compares transitions having a less than maximum length of application of reset potential differences to transitions having the maximum length of application of reset potential differences, the application of reset potential differences for the less than maximum application start (and thus also end) at different points within the maximum reset portion, i.e. within the maximum reset portion of the transition period. The “less than maximal reset time” reset pulses are thus distributed within the longest reset time period. Preferably they all end within said longest reset period. Preferably the starting times of transitions having substantially equal length of the reset portion differ.

In prior art driving schemes incorporating a reset portion of the transition period, the control means are arranged such that the reset pulse(s), i.e. the potential differences resulting in the reset, are all initiated at substantially the same time, for example all reset waveforms start to be implemented as soon as an image update signal is issued by the display controller, resulting in a less than smooth image change-over. In prior art driving schemes all picture element thus start changing their appearance at the start of the reset portion, and during the second half of the reset portion almost all picture elements are in an extreme optical state. This provides for an erratic image change over of image. In the invention the starting times for application of the reset potential differences are different for different pictures elements, and a more gradual change over of image is provided. This positive effect is achieved without lengthening the reset portion of the image transition period, since all resets are performed within the maximum reset portion.

In contrast, in the driving schemes in accordance with the invention, the ‘less than maximum duration’ pulses have different starting times which distributes these pulses over the maximum duration of the reset or grey scale driving portion of the image transition period, so that a more gradual change in image is produced.

The temporal spread in reset pulses or grey scale pulses due to the measures of the present invention means that for most of the image update time, at least a subset of all picture elements will be changing their visual appearance during the resetting portion and/or the grey scale driving portion of the image transition period. In this manner, the image transition is smoother and a visually less abrupt image update is realized. The image transition time period, however, has not been lengthened.

Only two parameters then determine the starting times, namely the optical states before and after application of the relevant potential difference.

In embodiments relating to the reset portion the drive means are then such arranged that the starting times of the application of the reset potential difference differ in dependence only on a starting optical state and a extreme optical state.

In embodiments relation to the grey scale driving portion without prior application of a reset pulse, the drive means are then such arranged that the starting times of the grey scale potentials differ in dependence only on a starting optical state and a final optical state.

These preferred embodiments provide for a simple scheme for application of grey scale and/or reset potential differences during the grey scale respectively reset portion of the image transition period. For instance, the length of the reset pulse (i.e. the duration of the application of a reset potential difference within the reset portion) to change a picture element from an initial light grey optical state to an intermediate white state is approximately the same as the length of the reset pulse to change a picture element from dark grey to black (if there are four different states). Within this simple scheme the reset pulse will start for the one transition at a different point in time than for the other transition, however the difference is only independent on two parameters, namely the optical state before application of the relevant potential difference and the optical state after application the relevant potential difference. These two parameters determine the starting times of the application of the reset or grey scale potential difference.

In preferred embodiments wherein reset and grey scale potential difference are applied the drive means in a further preferred embodiment are such arranged that the starting times differ in dependence on a starting optical state, an extreme optical state after reset, and a final optical state.

In these embodiments the starting times are dependent on three parameters instead of two, as in the simple embodiment. Using three determining parameters allows for more variation in the starting times and thereby for more possibilities to distribute the reset and grey scale pulses over the grey scale driving portion respectively reset portion of the image transition time period and thereby for a smoother image change, at the cost of a slightly more complicated driving scheme.

The driving method in accordance with the invention is characterized in that during said one or more portions of the image transition period, different starting times are provided for the application of the potential differences, within said one or more portions of the image transition period, for potential differences having a duration less than a maximum duration for said portion of the image transition period, in particular in preferred embodiments the starting times differ for the application of the potential differences of substantially equal, less than maximum, duration. The relevant portion may be a grey scale driving portion, in which case the potential differences are grey scale potential differences, a reset portion or an overreset portion in which cases the relevant potential differences are reset respectively overreset potential differences.

It is remarked that grey scales in electrophoretic displays are generally created by applying voltage differences for specified time periods. They are influenced by image history, dwell time, temperature, humidity, lateral inhomogeneity of the electrophoretic foils etc. Relatively accurate grey levels can be achieved using rail-stabilized approach, which means that the grey levels are always achieved either from reference black or from reference white state. In such driving schemes the transition between one grey level and another is actually often accomplished by a train of pulses, comprising the application of more than one type of potential differences, namely a reset pulse to bring the element to an extreme state, followed by a grey level pulse to bring the element from the extreme state to a determined grey level as is already mentioned above. Such driving method may, and in preferred embodiments does, use over-reset voltage pulses in which reset pulses largely exceeding the saturation time, i.e. the time required for the ink to switch from its present state to the full white/black saturated state, are used. In addition, to realize the lowest image retention a series of short AC pulses, so called preset or shaking pulses, may be, and in preferred embodiments are, supplied prior to the resetting and/or driving pulse in order to reduce the dwell time and/or image history effects, thus reducing image retention. In general it holds that, the more complex the total driving scheme, the larger the variation in length of the transition time from one image to a next may be between elements, the larger the problem the present invention seeks to overcome becomes and the more advantageous the invention becomes.

It is remarked that the different embodiments of the invention are directed to similar problems, and provide, to solve these similar problems, similar measures, and are all based on a common single inventive insight.

These and other aspects of the display panel of the invention will be further elucidated and described with reference to the drawings, in which:

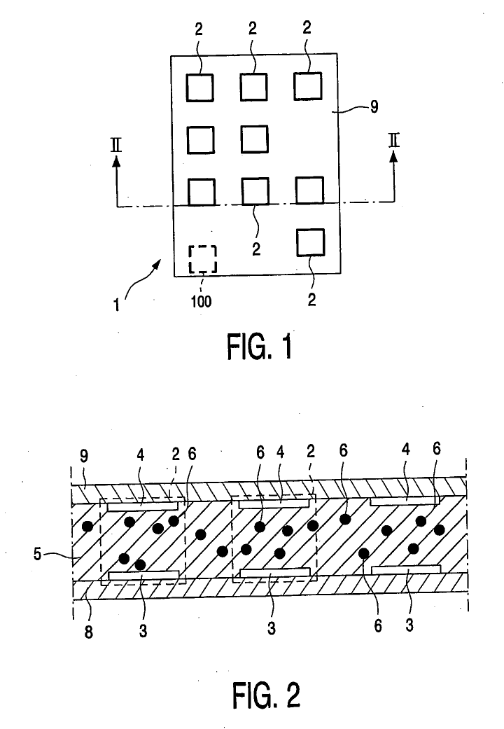

FIG. 1 shows diagrammatically a front view of an a display panel;

FIG. 2 shows diagrammatically a cross-sectional view along II-II in FIG. 1;

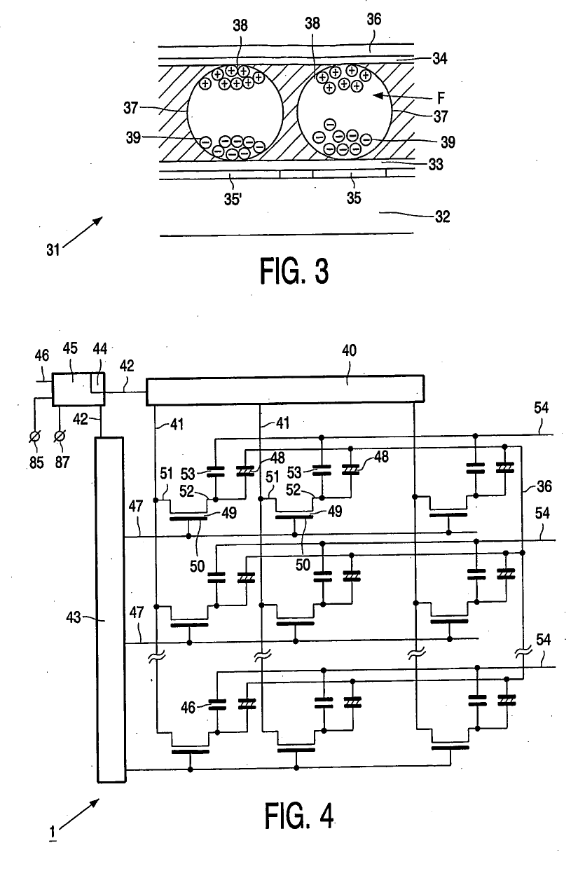

FIG. 3 shows diagrammatically a cross section of a portion of a further example of an electrophoretic display device;

FIG. 4 shows diagrammatically an equivalent circuit of a picture display device of FIG. 3;

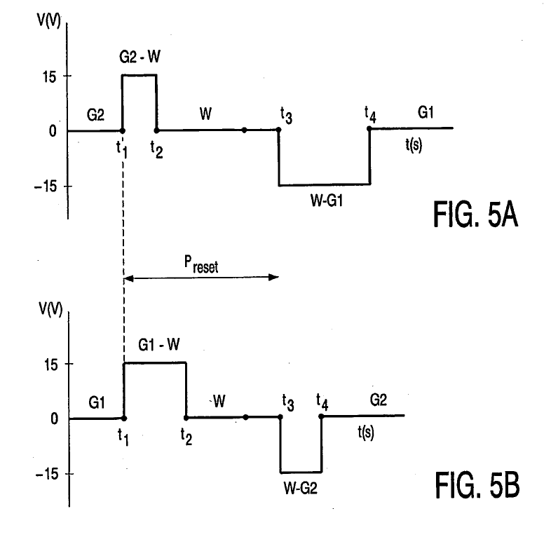

FIG. 5A shows diagrammatically the potential difference as a function of time for a picture element for one driving scheme;

FIG. 5B shows diagrammatically the potential difference as a function of time for a picture element for a further driving scheme;

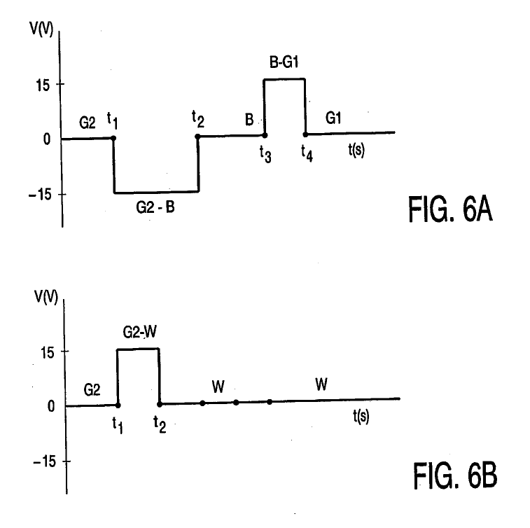

FIG. 6A shows diagrammatically the potential difference as a function of time for a picture element for a further driving scheme;

FIG. 6B shows diagrammatically the potential difference as a function of time for another picture element for a further driving scheme;

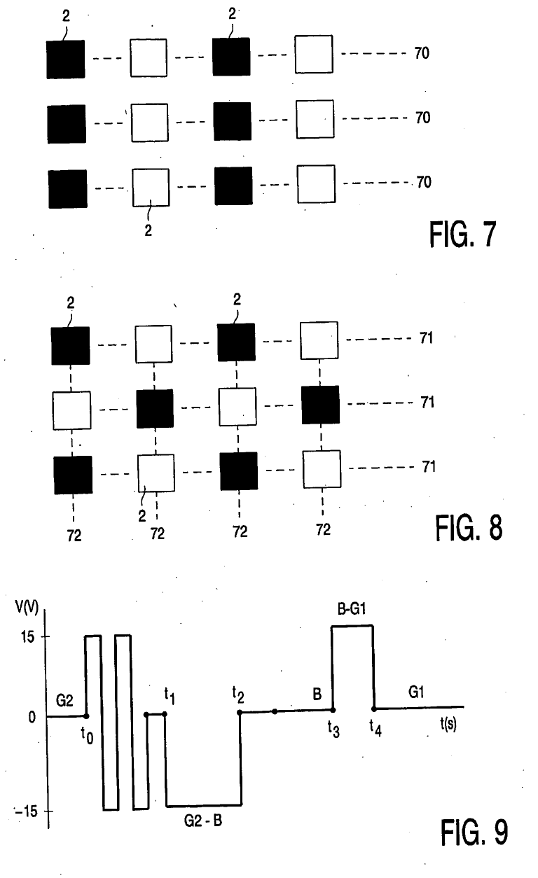

FIG. 7 shows the picture representing an average of the first and the second appearances as a result of the reset potential differences in another variation of the embodiment, and

FIG. 8 shows the picture representing an average of the first and the second appearances as a result of the reset potential differences in another variation of the embodiment;

FIG. 9 shows diagrammatically the potential difference as a function of time for a picture element;

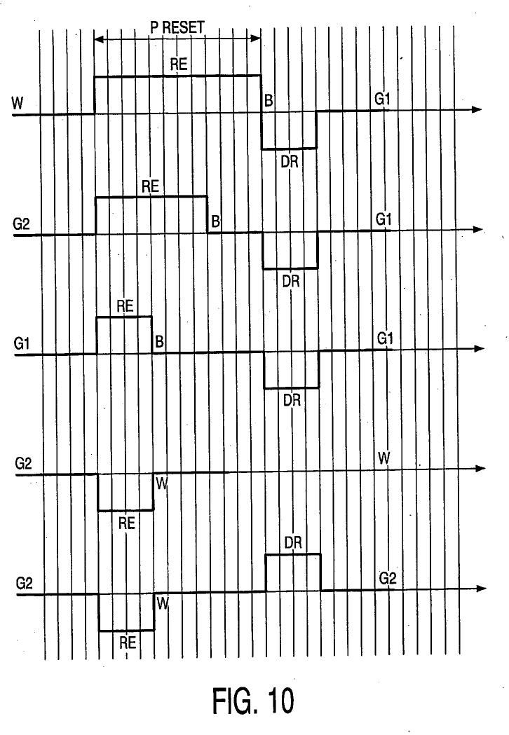

FIG. 10 illustrates driving schemes according to prior art;

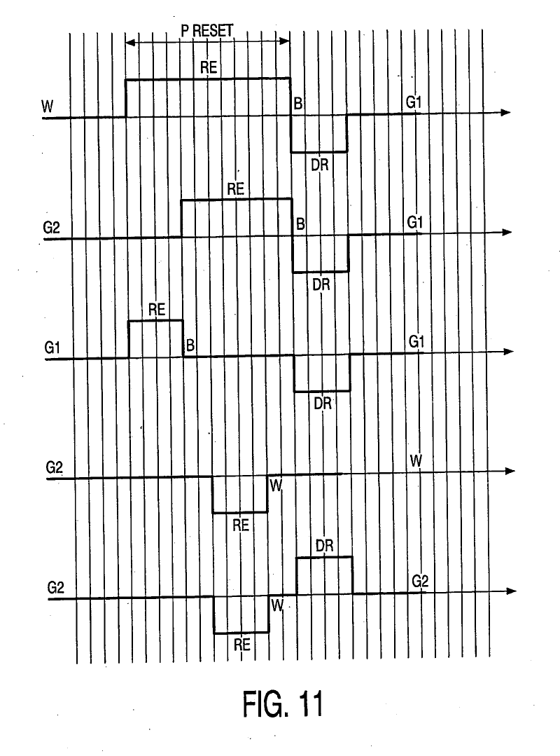

FIG. 11 illustrates driving schemes in accordance with the invention;

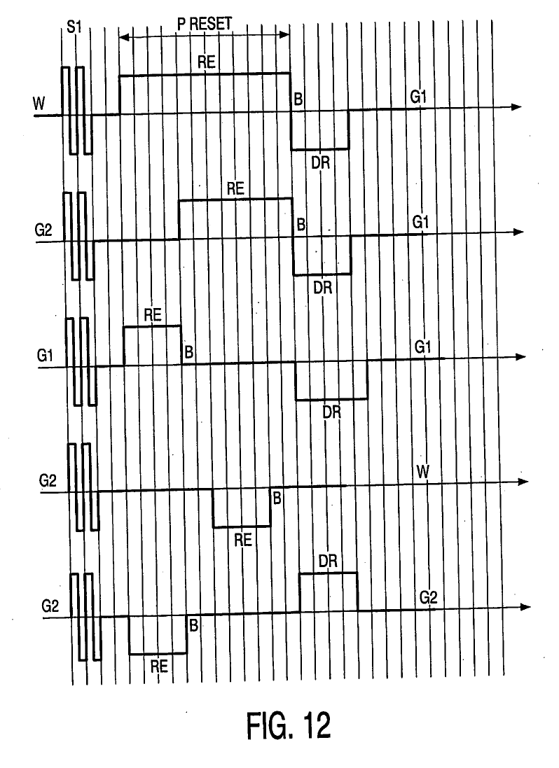

FIG. 12 illustrates further driving schemes in accordance with a preferred embodiment of the invention;

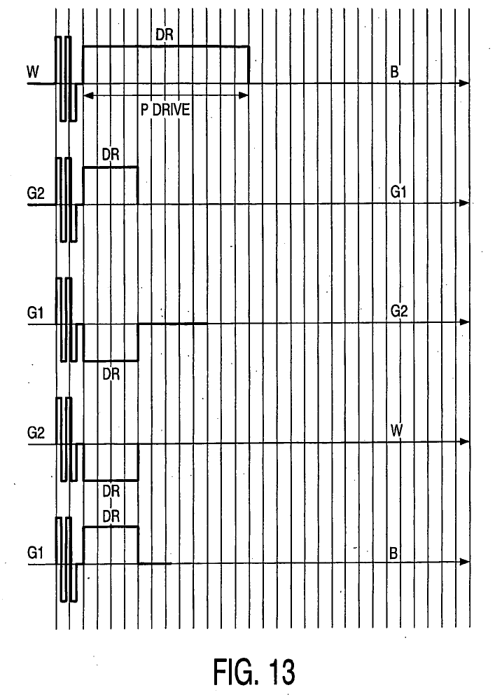

FIG. 13 illustrates a grey to grey driving scheme according to the prior art;

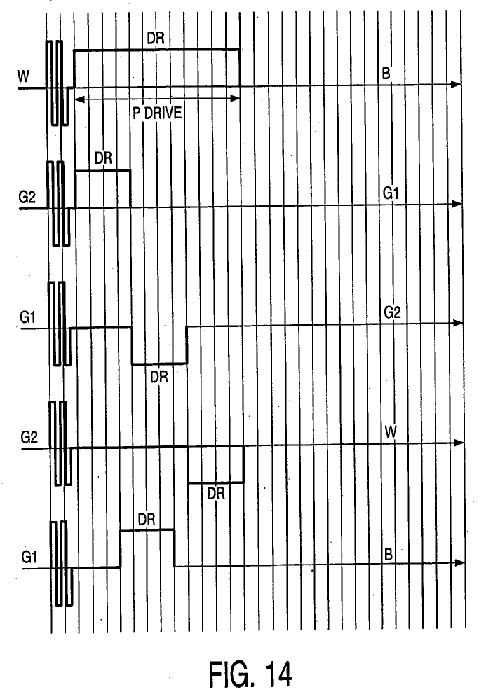

FIG. 14 illustrates a grey to grey driving scheme according to the invention.

In all the Figures corresponding parts are usually referenced to by the same reference numerals.

FIGS. 1 and 2 show an embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6, is present between the substrates 8,9. A first and a second electrode 3,4 are associated with each picture element 2. The electrodes 3,4 are able to receive a potential difference. In FIG. 2 the first substrate 8 has for each picture element 2 a first electrode 3, and the second substrate 9 has for each picture element 2 a second electrode 4. The charged particles 6 are able to occupy extreme positions near the electrodes 3,4 and intermediate positions in between the electrodes 3,4. Each picture element 2 has an appearance determined by the position of the charged particles 6 between the electrodes 3,4 for displaying the picture. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are arranged for controlling the potential difference of each picture element 2 to be a reset potential difference having a reset value and a reset duration for enabling particles 6 to substantially occupy one of the extreme positions, and subsequently to be a picture potential difference for enabling the particles 6 to occupy the position corresponding to the image information.

FIG. 3 diagrammatically shows a cross section of a portion of a further example of an electrophoretic display device 31, for example of the size of a few display elements, comprising a base substrate 32, an electrophoretic film with an electronic ink which is present between two transparent substrates 33, 34 for example polyethylene, one of the substrates 33 is provided with transparent picture electrodes 35 and the other substrate 34 with a transparent counter electrode 36. The electronic ink comprises multiple micro capsules 37, of about 10 to 50 microns. Each micro capsule 37 comprises positively charged white particles 38 and negative charged black particles 39 suspended in a fluid F. When a positive field is applied to the pixel electrode 35, the white particles 38 move to the side of the micro capsule 37 directed to the counter electrode 36 and the display element become visible to a viewer. Simultaneously, the black particles 39 move to the opposite side of the microcapsule 37 where they are hidden to the viewer. By applying a negative field to the pixel electrodes 35, the black particles 39 move to the side of the micro capsule 37 directed to the counter electrode 36 and the display element become dark to a viewer (not shown). When the electric field is removed the particles 38, 39 remain in the acquired state and the display exhibits a bi-stable character and consumes substantially no power.

FIG. 4 shows diagrammatically an equivalent circuit of a picture display device 31 comprising an electrophoretic film laminated on a base substrate 32 provided with active switching elements, a row driver 46 and a column driver 40. Preferably, a counter electrode 36 is provided on the film comprising the encapsulated electrophoretic ink, but could be alternatively provided on a base substrate in the case of operation using in-plane electric fields. The display device 31 is driven by active switching elements, in this example thin film transistors 49. It comprises a matrix of display elements at the area of crossing of row or selection electrodes 47 and column or data electrodes 41. The row driver 46 consecutively selects the row electrodes 47, while a column driver 40 provides a data signal to the column electrode 41. Preferably, a processor 45 firstly processes incoming data 43 into the data signals. Mutual synchronization between the column driver 40 and the row driver 46 takes place via drive lines 42. Select signals from the row driver 46 select the pixel electrodes 42 via the thin film transistors 49 whose gate electrodes 50 are electrically connected to the row electrodes 47 and the source electrodes 51 are electrically connected to the column electrodes 41. A data signal present at the column electrode 41 is transferred to the pixel electrode 52 of the display element coupled to the drain electrode via the TFT. In the embodiment, the display device of FIG. 3 also comprises an additional capacitor 53 at the location at each display element 48. In this embodiment, the additional capacitor 53 is connected to one or more storage capacitor lines 54. Instead of TFT other switching elements can be applied such as diodes, MIM's, etc.

As an example the appearance of a picture element of a subset is light gray, denoted as G2, before application of the reset potential difference. Furthermore, the picture appearance corresponding to the image information of the same picture element is dark gray, denoted as G1. For this example, the potential difference of the picture element is shown as a function of time in FIG. 5A. The reset potential difference has e.g. a value of 15 Volts and is present from time t₁ to time t₂, t₃ being the maximum reset duration, i.e. the reset period Preset. The reset duration and the maximum reset duration are e.g. 50 ms and 300 ms, respectively. As a result the picture element has an appearance being substantially white, denoted as W. The picture potential difference (grey scale potential difference) is present from time t₃ to time t₄ and has a value of e.g. −15 Volts and a duration of e.g. 150 ms. As a result the picture element has an appearance being dark gray (G1), for displaying the picture.

The maximum reset duration, i.e. the complete reset period, for each picture element of the subset is substantially equal and when overreset is applied than the time required to change the position of particles 6 of the respective picture element from one of the extreme positions to the other one of the extreme positions. For the picture element in the example the reference duration is e.g. 300 ms.

As a further example the potential difference of a picture element is shown as a function of time in FIG. 5B. The appearance of the picture element is dark gray (G1) before application of the reset potential difference. Furthermore, the picture appearance corresponding to the image information of the picture element is light gray (G2). The reset potential difference has e.g. a value of 15 Volts and is present from time t₁ to time t₂. The reset duration is e.g. 150 ms. As a result the picture element has an appearance being substantially white (W). The picture potential difference is present from time t3 to time t4 and has e.g. a value of e.g. −15 Volts and a duration of e.g. 50 ms. As a result the picture element has an appearance being light gray (G2), for displaying the picture. In the devices in accordance with the invention an overreset pulse may be applied in embodiments, i.e. the length and/or amplitude of the reset pulse between t₁ and t₂ is more powerful than nominally needed to bring the element into the desired extreme state. The application of an overreset has the advantage that any residual history effect is eliminated. It is absolutely sure that the element is in an extreme state.

In another variation of the embodiment the drive means 100 are further arranged for controlling the reset potential difference of each picture element to enable particles 6 to occupy the extreme position which is closest to the position of the particles 6 which corresponds to the image information. As an example the appearance of a picture element is light gray (G2) before application of the reset potential difference. Furthermore, the picture appearance corresponding to the image information of the picture element is dark gray (G1). For this example, the potential difference of the picture element is shown as a function of time in FIG. 6A. The reset potential difference has e.g. a value of −15 Volts and is present from time t₁ to time t₂. The reset duration is e.g. 150 ms. As a result, the particles 6 occupy the second extreme position and the picture element has a substantially black appearance, denoted as B, which is closest to the position of the particles 6 which corresponds to the image information, i.e. the picture element 2 having a dark gray appearance (G1). The picture potential difference is present from time t3 to time t4 and has e.g. a value of e.g. 15 Volts and a duration of e.g. 50 ms. As a result the picture element 2 has an appearance being dark gray (G1), for displaying the picture. As another example the appearance of another picture element is light gray (G2) before application of the reset potential difference. Furthermore, the picture appearance corresponding to the image information of this picture element is substantially white (W). For this example, the potential difference of the picture element is shown as a function of time in FIG. 6B. The reset potential difference has e.g. a value of 15 Volts and is present from time t₁ to time t₂. The reset duration is e.g. 50 ms. As a result, the particles 6 occupy the first extreme position and the picture element has a substantially white appearance (W), which is closest to the position of the particles 6 which corresponds to the image information, i.e. the picture element 2 having a substantially white appearance. The picture potential difference is present from time t₃ to time t₄ and has a value of 0 Volts because the appearance is already substantially white, for displaying the picture.

In FIG. 7 the picture elements are arranged along substantially straight lines 70. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along on each line 70 to enable particles 6 to substantially occupy unequal extreme positions. FIG. 7 shows the picture representing an average of the first and the second appearances as a result of the reset potential differences. The picture represents substantially middle gray.

In FIG. 8 the picture elements 2 are arranged along substantially straight rows 71 and along substantially straight columns 72 being substantially perpendicular to the rows in a two-dimensional structure, each row 71 having a predetermined first number of picture elements, e.g. 4 in FIG. 8, each column 72 having a predetermined second number of picture elements,. e.g. 3 in FIG. 8. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along on each row 71 to enable particles 6 to substantially occupy unequal extreme positions, and the drive means are further arranged for controlling the reset potential differences of subsequent picture elements 2 along on each column 72 to enable particles 6 to substantially occupy unequal extreme positions. FIG. 8 shows the picture representing an average of the first and the second appearances as a result of the reset potential differences. The picture represents substantially middle gray, which is somewhat smoother compared to the previous embodiment.

In variations of the device the drive means are further arranged for controlling the potential difference of each picture element to be a sequence of preset potential differences before being the reset potential difference. Preferably, the sequence of preset potential differences has preset values and associated preset durations, the preset values in the sequence alternate in sign, each preset potential difference represents a preset energy sufficient to release particles 6 present in one of the extreme positions from their position but insufficient to enable said particles 6 to reach the other one of the extreme positions. As an example the appearance of a picture element is light gray before the application of the sequence of preset potential differences. Furthermore, the picture appearance corresponding to the image information of the picture element is dark gray. For this example, the potential difference of the picture element is shown as a function of time in FIG. 9. In the example, the sequence of preset potential differences has 4 preset values, subsequently 15 Volts, −15 Volts, 15 Volts and −15 Volts, applied from time to to time t₁. Each preset value is applied for e.g. 20 ms. Subsequently, the reset potential difference has e.g. a value of −15 Volts and is present from time t₁ to time t₂. The reset duration is e.g. 150 ms. As a result, the particles 6 occupy the second extreme position and the picture element has a substantially black appearance. The picture potential difference is present from time t₃ to time t₄ and has e.g. a value of e.g. 15 Volts and a duration of e.g. 50 ms. As a result the picture element 2 has an appearance being dark gray, for displaying the picture. Without being bound to a particular explanation for the mechanism underlying the positive effects of application of the preset pulses, it is presumed that the application of the preset pulses increases the momentum of the electrophoretic particles and thus shortens the switching time, i.e. the time necessary to accomplish a switch-over, i.e. a change in appearance. It is also possible that after the display device is switched to a predetermined state e.g. a black state, the electrophoretic particles are “frozen” by the opposite ions surrounding the particle. When a subsequent switching is to the white state, these opposite ions have to be timely released, which requires additional time. The application of the preset pulses speeds up the release of the opposite ions thus the de-freezing of the electrophoretic particles and therefore shortens the switching time.

FIGS. 1 to 9 and their description describe general principals. FIGS. 10 to 14 are examples of a subset of the 16 image transition waveforms in the situation of an electrophoretic display comprising negatively charged white particles and positively charged black particles. FIG. 10 illustrates in a graphical form a reset driving schemes in accordance with prior art. The starting optical states, intermediate extreme states and final optical states are, from top to bottom
W-B-G1
G2-B-G1
G1-B-G1
G2-W-W
G2-W-G2
   where W stands for white, G2 for light grey, G1 for dark grey and B for black. Basically the darkness of the element has four grades, white, light grey, dark grey and black, two of which states are extreme states. Consequently there are 16 different combinations of starting optical state and final optical state, and there are eight different transitions from a starting state to an intermediate extreme state, if each step from one state to another is expressed as a step, the reset pulse can be in four different strengths (0,1,2,3), i.e. there are four different duration of application of the reset potential difference, with two different signs (positive or negative).

If there are n-grades, then the number of combinations starting optical state-final state is n², the number of different combinations starting state-intermediate extreme state is 2n, and the strength of the reset pulse can be in n different strengths in two different signs.

In the scheme shown in FIG. 10 the maximum duration of the reset portion P Reset is indicated, which is equivalent to the duration of application of a reset potential difference to bring an optical element form one extreme optical state White (W) to the other extreme optical state Black (B). All reset pulses start at the beginning of the maximum reset portion P RESET of the image transition period. Or in other words for all transitions the starting time of the application of the reset potential difference is the same. Consequently all changes in the plurality of picture elements take place right after the start of the reset portion P RESET of the image transition period, and at the end of the reset portion of the image transition period the image is static. This holds the more if use is made of over-reset pulses. The very fast changing image at the beginning of the portion P RESET and the static image and the end of P RESET provides for a less than smooth transition of images.

FIG. 11 shows a scheme in accordance with the invention. The difference with the scheme shown in FIG. 10 is that the starting times for the reset pulses, i.e. for the application of the reset potential difference differ, and more in particular for those transitions having reset pulses of the same lengths (in this example the transitions
G1-B-G1
G2-W-W
G2-W-G2)
   start (and thus also end) at different times within the maximum reset period P RESET. Thus the application of reset pulses is distributed within the maximum reset time portion P RESET. A visually less abrupt image update is achieved. It is remarked that the feature which sets the invention apart from other schemes is the fact that the starting time for the reset pulses differs when transitions with substantially the same length of reset pulse are compared. At each or nearly each instance within P RESET some change in the image is visible. Prima facie in a simple driving scheme in the prior art pulses of equal length start at the same time, which seems logical, however this is not the case (at least not for all transitions) in a device in accordance with a preferred embodiment of the invention, despite the fact that the reset pulses are “equal” meaning of equal length, they start at different times, so that at least some of the shorter reset or overreset pulses (i.e. shorter than maximum reset or overreset pulse) are distributed over the longest reset time period.

In FIG. 11 the starting time of the reset pulse is dependent on the starting optical state and the intermediate optical state. Using two parameters, instead of only one (the length of the pulse makes it possible that the reset pulse G1-B (third line) starts (and thus also ends) at a different point in time then the reset pulses G2-W (fourth and fifth line) even though the pulses have the same duration. In FIG. 12 a more complex scheme is presented in which the starting time is not just dependent on the starting and intermediate extreme optical state, but also on the final state. This allows for even more variations in the starting time of the reset pulses, thus for an even more smoother image update. Furthermore FIG. 12 shows the application of preset or shaking pulses S1 prior to application of the reset pulses. Within preferred embodiments preset or shaking pulses are applied prior to application of reset potential differences and/or grey scale potential differences. The image transition period is the time period between one image and a next. This transition image period has one or more portions. The portions may comprise a shaking portion S1, but in particular a reset portion P RESET, and a grey scale driving portion P DRIVE.

FIG. 13. illustrates in a graphical form a driving scheme without reset in accordance with prior art. Here a direct transition is realized from the grey level of the previous image to that of the following image. The starting optical states and final optical states are, from top to bottom
W-B
G2-G1
G1-G2
G2-W
G1-B
   In the scheme shown in FIG. 13 all grey scale pulses start at the beginning of the grey scale driving portion P DRIVE of the image transition period. Consequently all changes in the element take place right after the start of the driving period, and at the end of the driving period the image is static. The static image and the end of the driving period provides for a less than smooth transition of images.

FIG. 14 shows a scheme in accordance with the invention. The difference with the scheme shown in FIG. 11 is that the grey scale pulses for those transitions having grey scale pulses of the same lengths and with a duration less than P DRIVE; in this example the transitions
G2-G1
G1-G2
G2-W
G1-B
   start (and thus also end) at different times within the maximum driving period P DRIVE. Thus the application of grey scale pulses is distributed within the longest driving time period P DRIVE. A visually less abrupt image update is achieved. It is remarked that the feature which sets the invention apart from other schemes is the fact that the starting time for the grey scale pulses differs when transitions are compared to those in which a grey scale driving pulses of maximum duration. In particular in preferred embodiments when transitions with substantially the same length of grey scale pulse are compared to each other a difference in starting time is seen. Prima facie in a simple driving scheme in the prior art pulses of equal length start at the same time, which seems logical, however this is not the case (at least not for all transitions) in a device in a preferred embodiment in accordance with the invention, despite the fact that the grey scale pulses are “equal”, meaning of equal length, they start at different times, so that at least some of the shorter grey scale pulses (i.e. shorter than maximum grey scale pulse duration) are distributed over the longest driving time period. In all the examples the grey scale pulses and the reset pulses remain single pulses, i.e. pulse with a single starting and end point.

It is further remarked that the above-mentioned embodiments illustrate rather than limit the invention, and that those skilled in the art will be able to design many alternative embodiments without departing from the scope of the appended claims. For example, although most embodiments in accordance with the invention are described with respect to an electrophoretic ink display, the invention is also suitable for electrophoretic displays in general and for bi-stable displays. Usually, an electronic ink display comprises white and black particles which allows to obtain the optical states white, black and intermediate grey states. Although only two intermediate grey scales are shown, more intermediate grey scales are possible. If the particles have other colors than white and black, still, the intermediate states may be referred to as grey scales. The bi-stable display is defined as a display wherein the pixel substantially maintains its grey level/brightness after the power/voltage to the pixel has been removed.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer, as well as any program product comprising program code means for use in display panel in accordance with the invention, for performing the action specific for the invention. In particular, the driving schemes may be implemented in hard-ware form, in soft-ware form, or a mixture of the two.

In short the invention may be described by:

The driving schemes for electrophoretic display panels are such arranged that the reset pulses and/or the grey scale pulses are distributed over the maximum reset or maximum driving period. Hereby a smoother image transition is provided.

The present invention has been described in terms of specific embodiments, which are illustrative of the invention and not to be construed as limiting. For example, whilst examples have been illustrated where either reset pulses or grey scale pulses have been distributed within reset and driving portions of the image transition period, it is clear that in further embodiments both reset pulses and grey scale pulses can be distributed within respectively the reset and driving portions of the same waveforms. The invention may be implemented in hardware, firmware or software, or in a combination of them. Other embodiments are within the scope of the following claims.

It will be obvious that many variations are possible within the scope of the invention without departing from the scope of the appended claims.

It is remarked that use of the invention may, of course, be established by means of determining the waveforms, or analyzing the computer programs or circuits for formation of the waveforms. It is however, equally possible to measure for many pixels, the light output, i.e. the way in which the transition is made between one optical state and another, and thereby establish the spread in time and the maximum transition period.

1. An electrophoretic display panel,
comprising:
an electrophoretic medium comprising charged particles;
a plurality of picture elements;
electrodes associated with each picture element for receiving a potential difference, the charged particles being able to occupy extreme positions near the electrodes and intermediate positions in between the electrodes; the extreme positions being associated with extreme optical states; and
drive means,
the drive means being arranged for providing, within an image transition period, the image transition period comprising one or more portions, to each of the plurality of picture elements
a grey scale potential difference, during a grey-scale driving portion of the image transition period, for causing the particles to occupy the position corresponding to image information, wherein
the drive means are arranged for providing, during said one or more portions of the image transition period, different starting times for the application of the potential differences, within said one or more portions of the image transition period, for potential differences having a duration less than a maximum duration for said portion of the image transition period.

2. An electrophoretic display panel according to claim 1 wherein the drive means are arranged such that the starting times differ for the application of the potential differences of substantially equal, less than maximum, duration.

3. An electrophoretic display panel according to claim 1 or 2 wherein the drive means are arranged for providing different starting times for application of the grey scale potential difference within the grey scale driving portion of the transition period for grey scale potential differences having an application duration less than the maximum duration for the grey scale driving portion.

4. An electrophoretic display panel according to claim 1 or 2 wherein the drive means are arranged for providing, within a reset portion of the image transition period, said reset portion preceding the grey scale driving portion, to each of the plurality of picture elements
a reset potential difference for causing the particles to substantially occupy an extreme position before application of the grey scale potential difference,
wherein the drive means are arranged for providing different starting times for application of the reset potential difference within the reset portion of the image transition period for transitions in which the duration of the application of the reset potential difference is less than the maximum duration for the reset portion.

5. An electrophoretic display panel as claimed in claim 1 or 2, characterized in that the drive means are arranged such that the starting times differ in dependence only on a starting optical state before application of the potential difference and a final optical state after application of the potential difference.

6. An electrophoretic display panel as claimed in claim 5 and 3, characterized in that the drive means are arranged such that the starting times of application of reset potential differences differ in dependence only on a starting optical state before application of the reset potential difference and an extreme optical state after reset.

7. An electrophoretic display panel as claimed in claim 5 and 2, characterized in that the drive means are arranged such that the starting times of application of grey scale potential differences differ in dependence only on a starting optical state before application of the grey scale potential difference and a final optical state after said application.

8. An electrophoretic display panel as claimed in claim 5 and 3, characterized in that the drive means are arranged such that the starting times differ in dependence on a starting optical state, an extreme optical state after reset, and a final optical state.

9. An electrophoretic display panel as claimed in claim 5, characterized in that the drive means are arranged for applying an over-reset potential difference, an over-reset potential difference being a reset potential difference applied for a duration substantially longer than needed to bring a picture element to an extreme optical state.

10. An electrophoretic display panel as claimed in claim 1, 2 or 3, characterized in that the drive means are arranged for providing to each picture element a preset potential difference prior a application of a reset and/or a grey scale potential difference, a preset potential difference being constituted of a series of short pulses.

11. A method for driving an electrophoretic display device in which method reset and grey scale potential differences are applied to an array of picture elements of the display device within an image transition period for providing a change of image on the display device wherein within an image transition period, the image transition period comprising one or more portions, to each of the plurality of picture elements a grey scale potential difference is provided during a grey-scale driving portion of the image transition time period, for causing the particles to occupy the position corresponding to image information.
wherein during said one or more portions of the image transition period, different starting times are provided for the application of the potential differences, within said one or more portions of the image transition period, for potential differences having a duration less than a maximum duration for said portion of the image transition period.

12. A method for driving an electrophoretic display device as claimed in claim 11 wherein the starting times differ for the application of the potential differences of substantially equal, less than maximum, duration.

13. A method for driving an electrophoretic display device as claimed in claim 11 or 12 wherein grey scale potential differences are applied within the grey scale portion of the image transition period, wherein different starting times for application of the grey scale potential difference within the grey scale driving portion of the transition period for grey scale potential differences having an application duration less than the maximum duration for the grey scale driving portion.

14. A method for driving an electrophoretic display device as claimed in claim 11 or 12 wherein a reset potential difference for causing the particles to substantially occupy an extreme position before application of the grey scale potential difference is provided within a reset portion of the image transition period preceding the grey scale driving portion of the image transition period
wherein different starting times are provided for application of the reset potential difference within the reset portion of the image transition period for transitions in which the duration of the application of the reset potential difference is less than the maximum duration for the reset portion.

15. Driving means for an electrophoretic display panel as claimed in any of the claims 1 to 10.
